(19) United States
(12) Patent Application Publication
(10) Pub. No.: US 2026/0176918 A1
(43) Pub. Date: Jun. 25, 2026

(54) HEAT SINK CANTILEVER MOUNT FOR A DRIVE MOTOR DISPOSED WITHIN A DRUM IN A ROLL-UP DOOR AND ASSEMBLY

(71) Applicant: ASI Doors, Inc., Milwaukee, WI (US)

(72) Inventors: George F. Balbach, Lake Bluff, IL (US); Jonathon M. Haggerty, Whitefish Bay, WI (US); Jeffrey W. Burnett, Raymond, WI (US)

(21) Appl. No.: 19/427,257

(22) Filed: Dec. 19, 2025

Related U.S. Application Data
(60) Provisional application No. 63/737,226, filed on Dec. 20, 2024.

(51) Int. Cl. E06B 9/72; E06B 9/80; H02K 5/04; H02K 9/22

(52) U.S. Cl. CPC E06B 9/72; H02K 5/04; H02K 9/227; E06B 9/80

(57) ABSTRACT

A drive motor is placed partially within the drum of a roll-up door and placed such that the motor elements are not in contact with the inside of the drum. This configuration requires that the drive motor be mounted at one end to the door frame in a cantilevered fashion and that the other end be mounted to a connector that engages the inside of the drum. The cantilevered mount provides means for space saving natural convection cooling to protect the motor (including its brake and transmission components) from overheating.

This application claims priority to U.S. Provisional Patent App. No. 63/737,226 filed Dec. 20, 2024.

### FIELD OF THE INVENTION

The present invention relates generally to flexible doors or curtains of the type that can be quickly rolled upwardly to an “open” position to provide access to a bay or other facility area and then be quickly rolled downwardly to a “closed” position to seal off access to the bay or other facility area as may be desired or required. In the relevant industry, such doors are referred to as “roll-up” doors. Rapid opening and closing of such flexible roll-up doors is required in applications where materials must be moved through the doorway of a facility from one side of the door to the other while dust and other contaminants are intended to be kept out. Such roll-up doors can be used to prevent contamination when used in relatively sterile environments or where cold air is intended to be retained within a cold storage area, by way of example. In clean rooms of pharmaceutical or other relatively sterile processing facilities, the interior of the facility can be pressurized above ambient such that, when the flexible roll-up door is raised to its “open” position, air will be forced out of the bay or opening and the door can be quickly lowered to its “closed” position without dust or contaminants having entered the bay or opening due to the forced outflow of air. Such doors are typically made of cloth and/or multi-filament PVC coated curtain material, although other materials can be used.

More specifically, the invention also relates to such roll-up doors having a rotatable drum that is used to raise and lower the door - the former to open the door and the latter to close it, which is also referred to herein as “cycling.” As used herein, the words “open” and “close” have their plain and ordinary meaning. The door is designed to wrap around the drum when the drum is rotated in one direction (door open) and unwrap it from the drum when the drum is rotated in the other direction (door close). The drum is rotated by a drive motor that is typically mounted to one end of the drum and outside the drum. The present invention, however, is configured to have the drive motor disposed within the drum to create a more compact design. Repeated cycling of the drum and drum motor generates heat within the drum. The present invention also relates to ways to dissipate heat from the drive motor that is disposed substantially within the drum.

### BACKGROUND OF THE INVENTION

As alluded to above, the proper operation and functionality of a flexible roll-up door depends primarily on the ability of the drum to rapidly and repeatedly raise and lower (or open and close) the door. This is done by actuation of the drive motor. In most flexible roll-up door applications, the drive motor is disposed outside of the drum but must have direct or indirect linkage to the drum to effect this rotation.

### SUMMARY OF THE INVENTION

In accordance with the present invention, the drive motor is placed at least partially within the drum and placed such that the motor elements are not in contact with the inside of the drum. This configuration requires that the drive motor be mounted at one end to the door frame in a cantilevered fashion and that the other end be mounted to a connector that engages the inside of the drum. The cantilevered mount provides means for space saving natural convection cooling to protect the motor (including its brake and transmission components) from overheating and also provides means for the motor to be used as a stressed member for increasing rigidity while reducing size and weight of the assembly. This is accomplished by placing the motor and related components within what is otherwise an empty cavity. The connector further provides means for increasing rigidity of the cantilevered mount.

The foregoing and other features of the present invention will be apparent in the detailed description that follows.

### BRIEF DESCRIPTION OF THE DRAWINGS

FIG. 1 is a schematic front elevational view of the structure in accordance with one embodiment of the present invention.

FIG. 2 is a schematic front elevational view of a second embodiment of the structure in accordance with the present invention.

### DETAILED DESCRIPTION OF THE INVENTION

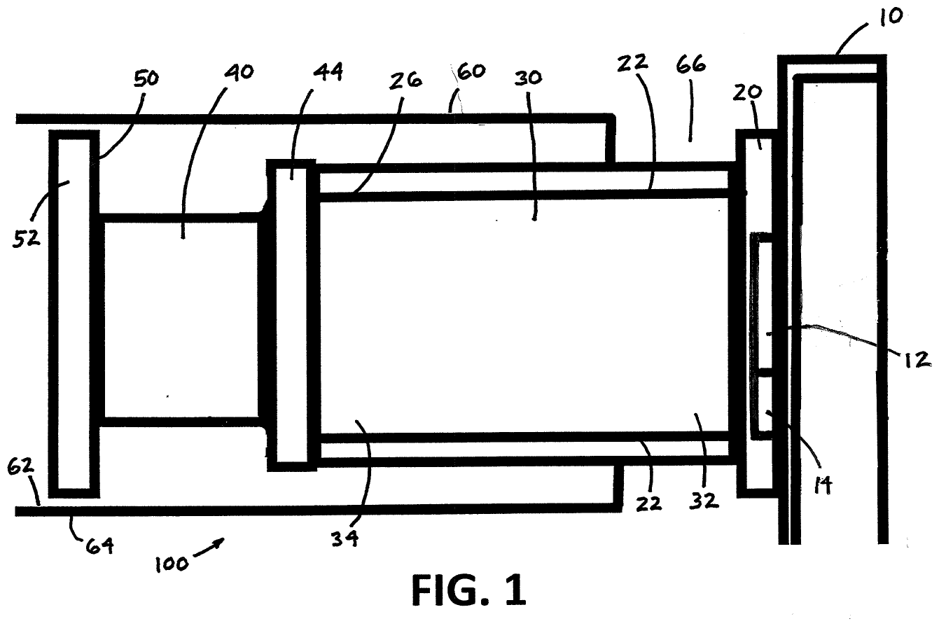

Referring now to the drawings in detail, wherein like-numbered elements refer to like elements throughout, FIG. 1 illustrates a heat sink cantilever mount assembly, generally identified 100, for a drive motor within a drum. More specifically, and moving from right to left relative to FIG. 1, a frame, generally identified 10, is mounted to one side of the door opening where the roll-up door (not shown) will be used. A heat sink, generally identified 20, is disposed to the left of the frame 10 and between the frame 10 and a motor, generally identified 30. This side of the frame 10 can be considered the motor-side of the frame 10. The motor 30 comprises a proximal end 32 and a distal end 34. Attached to the distal end 34 of the motor 30 is a transmission, generally identified 40. By means of a drive shaft, the transmission 40 is, in turn, secured to a connector element, generally identified 50. The connector element 50 has an outer diameter and an outer perimeter surface 52.

Lastly, a drum (or hollow tube-like or cylindrical structure), generally identified 60, is provided. The drum 60 has an inner diameter. The outer diameter of the connector element 50 is less than the inner diameter of the drum 60. The drum 60 has an inner surface 62 and an outer surface 64. A portion of the inner surface 62 of the drum 60 is attached to the outer surface 52 of the drum connector 50. It is to be understood that only a portion of the drum 60 is shown for purposes of illustration. The drum 60 has a length that extends fully, or near fully, across a doorway. The drum 60 rotates about an axis. At the opposite end (not shown) of the drum 60 is complementary supporting structure for the drum 60 such that the drum 60 is disposed in a substantially horizontal position. This would be considered the “idler side” of the drum, as compared to the “drive side” of the drum 60 which is the primary subject of the present invention. This horizontal positioning (about the drum axis) is required because the outer surface 64 of the drum 60 carries with it a roll-up door (also not shown) which must be rolled up such that each side is pulled upwardly or lowered downwardly to open and close the roll-up door, which is done quickly and repeatedly. If the drum 60 is not substantially horizontal, the door will wrap unevenly causing a complete loss of intended functionality. That is, the door is symmetrical for the overall width, the left and right sides of the door being equal in width and having mirror symmetry to the door center.

It should also be appreciated that the frame 10 has secured to it a brake adapter mount plate (not shown). To the right side of the frame 10, the brake adapter mount plate is bolted to the frame 10 using a plurality of fasteners. The mount plate also has mounted to it a brake 12. This brake 12 is used to seize rotation of the motor 30 as required during cycling. The mount plate also includes an electrical wiring enclosure 14. Another part of the wiring enclosure 14 is placed below the motor 30. Lastly, the brake adapter mount plate has secured to it a plurality of heads that are provided as part of the heat sink 20 structure previously mentioned.

The plurality of heads mentioned immediately above comprise one end of a tensioned fastener 22 that is used with the heat sink 20 structure. Each tensioned fastener 22 is essentially a relatively long rod structure that passes through an aperture (not shown) in the mount plate, then through an aperture (also not shown) in the heat sink 20 and then along the sides of the motor 30. It should be noted that the heat sink structure 20 is a flat plate-like structure as shown in FIG. 1. In this configuration, any heat generated by the motor 30 is effectively transferred to the tensioned fasteners 22 by thermal conduction. That is, thermal energy generated by the motor 30 has higher kinetic energy than that of the surrounding tensioned fasteners 22. This thermal energy tends to move to, or be transferred to, the heat sink 20 and the tensioned fasteners 22. That is, the proximal end 32 of the motor 30 also transfers heat directly to the heat sink 20 by conduction. As this heat is transferred by conduction to the heat sink 20, heat is then dissipated by convection into the ambient air from the heat sink 20. It is to be noticed in FIG. 1 that there is a circumferential air gap 66 between that end of the drum 60 and the frame 10. This air gap 66 allows a portion of the proximal end 32 of the motor 30 to be exposed to ambient air. However, by the direct conduction of heat from the motor 30 to the heat sink 20, and by the conduction of heat from the motor 30 to the tensioned fasteners 22 and then to the heat sink 20, it is the heat sink 20 that dissipates most of the heat generated by the motor 30 within the drum 60. This heat dissipation allows the motor 30 and its other connected structure to not overheat during cycling. In short, this construction enables space saving placement of the motor 30 combined with natural convection cooling to protect the motor 30, the brake 12, and the transmission 40 from overheating during operation.

The presence of the tensioned fasteners 22 provides another significant structure and functionality to the assembly 100 in accordance with the present invention. Specifically, the configuration illustrated in FIG. 1 demonstrates that the motor 30 and the structural elements that extend beyond the distal end of the motor 30 are mounted in a cantilevered fashion. This cantilevered functionality is provided in substantial part by the tensioned fasteners 22. This resists deformation or drooping of the overhung motor 30 within the drum 60 during rotation. As is also shown in FIG. 1, the distal end of the motor 30 includes the transmission 40. In combination with the motor 30, the transmission 40 can rotate in both directions which allows the connector 50, when connected to the drum 60 via at least one fastener (not shown), to rotate the drum 60 as required for rolling the roll-up door open and closed. Further, the transmission 40 serves as a speed reducer as the roll-up door nears its fully open or fully closed position. The transmission 40 further comprises a flange 44. The flange 44 of the transmission 40 comprises a plurality of apertures (not shown) in it. Each aperture receives the distal end 26 of each tensioned fastener 22. Once the distal end 26 of each respective fastener 22 extends beyond the flange 44, a second fastener is used to secure the fastener 22 in place and, in turn, place the motor 30 in its cantilevered position as a stressed member for increasing rigidity while reducing size and weight of the assembly.

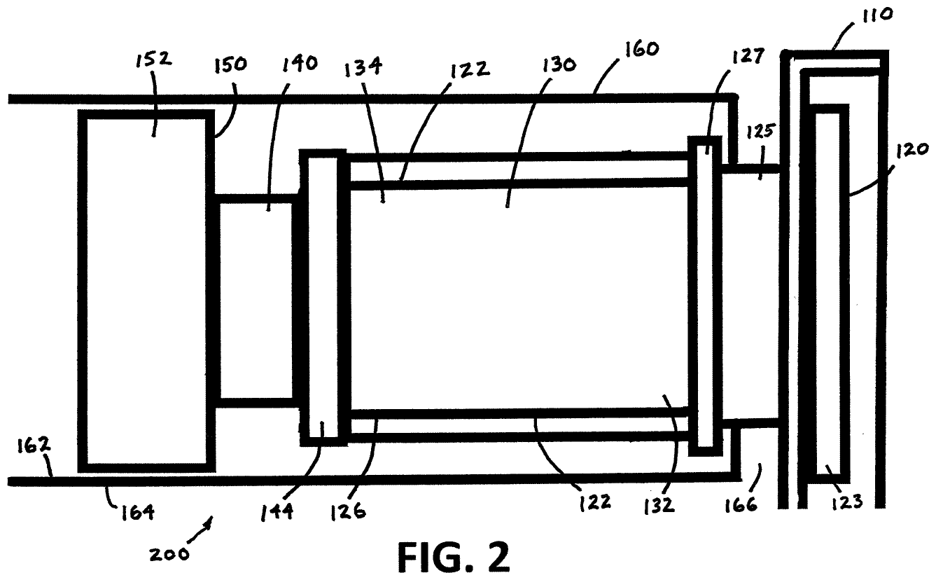

Referring now to FIG. 2, it shows an alternative embodiment of the present assembly, generally identified 200, for a drive motor within a drum. Once again moving from right to left relative to FIG. 2, a frame, generally identified 110, is mounted to one side of the door opening where the roll-up door (not shown) will be used. This alternative embodiment does away with the plate and heat sink 20 of the first embodiment in that both structures are essentially replaced by a one piece heat sink motor adapter mount, generally identified 120. A motor, generally identified 130, is disposed to the left of the frame 110. Attached to the distal end 134 of the motor 130 is a transmission, generally identified 140. The transmission 140 is, in turn, secured to a connector element, generally identified 150. The connector element 150 has an outer perimeter surface 152. Lastly, a drum, generally identified 160, is provided. The drum 160 has an inner surface 162 and an outer surface 164. A portion of the inner surface 162 of the drum 160 is attached to the outer perimeter surface 152 of the connector element 150. It is again to be understood that only a portion of the drum 160 is shown for illustrative purposes. The drum 160 has a length that extends fully, or near fully, across the doorway. The drum 160 rotates about an axis. At the opposite end (not shown) of the drum 160 is a complementary supporting structure for the drum 160 such that the drum 160 is disposed in a substantially horizontal position. This is required because the outer surface 164 of the drum 160 carries with it the roll-up door (also not shown) as previously described relative to the first embodiment.

As previously alluded to, the frame 110 has secured to it a heat sink motor adapter mount 120. To the right side of the frame 110 shown in FIG. 2, the heat sink motor adapter mount 120 comprises a flange 123 that is shown bolted to the frame 110 using a plurality of fasteners (not shown). Another portion 125 of the heat sink motor adapter mount 120 extends through an aperture (not shown) in the frame 110 and comprises a combined motor mount and heat sink mount flange 127. This heat sink motor adapter mount 120, and the flange portion 123 in particular, houses the brake (not shown). This brake is used to seize rotation of the motor 130 as required by operation of the assembly 200. Referring to the same side of the frame 110, an electrical wiring enclosure assembly (not shown) is also included. The electrical wiring enclosure assembly makes it easier for a user to access the electrical components of the assembly 200. Lastly, the combined motor mount and heat sink mount flange 127 of the heat sink motor adapter mount 120 comprises a plurality of apertures (not shown) defined in it. Each aperture is used to secure the head of a tensioned fastener 122 of the type previously discussed and discussed below.

The plurality of heads mentioned immediately above are disposed to one end of the tensioned fastener 122 that is used with the heat sink 120 structure. Each tensioned fastener 122 is essentially a relatively long rod structure that passes through an aperture in the heat sink motor adapter mount flange 127, runs along the sides of the motor 130, and is anchored at the transmission flange 144, the flange 144 of the transmission 140 comprising a plurality of apertures (not shown) in it. Each aperture receives the distal end 126 of each tensioned fastener 122. Once the distal end 126 of each respective fastener 122 extends beyond the flange 144, a second fastener is used to secure the fastener 122 in place and, in turn, place the motor 130 in its cantilevered position as a stressed member. In this configuration, any heat generated by the motor 130 and the transmission 140 is effectively transferred to the tensioned fasteners 122 by thermal conduction. As with the first assembly 100, thermal energy generated by the motor 130 has higher kinetic energy than that of the surrounding tensioned fasteners 122. This thermal energy tends to move to, or be transferred to, the heat sink motor adapter mount 120. The proximal end 132 of the motor 130 also transfers heat directly to the heat sink motor adapter mount 120 by conduction. As this heat is transferred by conduction to the heat sink motor adapter mount 120, heat is then dissipated by convection into the ambient air from the heat sink 120. It is to be recognized in FIG. 2 that there is an air gap 166 between that end of the drum 160 and the frame 110. Natural convection cooling occurs by the direct conduction of heat from the motor 130 to the heat sink motor adapter mount 120, and by the direct conduction of heat from the motor 130 to the tensioned fasteners 122 and then to the flange 127 of the heat sink motor adapter mount 120. This heat dissipation keeps the motor 130 and its other connected parts from overheating during door cycling.

As with the first assembly 100, the presence of the tensioned fasteners 122 provides an added dimension of functionality to the assembly 200 in accordance with the present invention. Specifically, the configuration illustrated demonstrates that the motor 130 and the structural elements that extend beyond the distal end 134 of the motor 130 are mounted in a cantilevered fashion. Again, this minimizes deformation or drooping of the motor 130 within the drum 160 during rotation. In combination with the motor 130, the transmission 140 can rotate in both directions which allows the connector element 150, when fastened to the drum 160, to rotate the drum 160 as required for opening and closing the roll-up door. Further, the transmission 140 serves as a speed reducer as the roll-up door nears its fully open or fully closed position. The transmission 140 further comprises a connector flange 144.

Relative to the connector element 150 of the second embodiment 200, it is to be understood that the connector element 150 comprises an outer hub 152, an inner hub (not shown), a bearing (also not shown), and a flexible shaft coupling (also not shown). These structures allow the connector element 150 to be secured to a shaft (not shown) that extends from the transmission 140 and further allow structural support by the transmission 140 and motor 130 mounted in a cantilever fashion as needed during cycling of the drum 160. It is to be understood that other structure exists or can exist within the connector element 150 and the transmission 140. It is also to be noted that the connector element 50 of the first assembly 100 has a thickness. However, the connector element 150 of the second assembly 200 has a thickness that is greater than that of the connector element 50 of the first assembly 100. This thickness can be significantly greater such that the outer surface 152 of the connector 150 is in substantially more contact with the inner surface 162 of the drum 160 along the axis of the drum 160. This embodiment provides greater stability to the assembly 200 and relieves more of the load placed on the tensioned fasteners 122. In the preferred embodiment, an even number of fasteners (not shown) are used and are spaced equally around the drum 160. This spacing improves rotational balance, especially when fasteners used to secure the drum 160 and connector element 150 are inserted using a “criss-crossed” pattern.

We claim:

1. A drum mount for use with a roll-up door disposed within a doorway comprising:
a frame mounted about the doorway including a portion mounted to one side of the doorway;
a drum rotatable about an axis;
a motor-side of the frame;
a motor for rotating the drum, the motor extending into the drum from the motor-side of the frame;
a heat sink disposed between the motor-side of the frame and one end of the motor; and
wherein the motor and the connector element are mounted in a cantilevered fashion from the frame and the heat sink.

2. The drum mount of claim 1 further comprising:
a transmission extending from the motor and into the drum; and
wherein the connector element extends from the transmission and into the drum.

3. The drum mount of claim 1 wherein the drum comprises an end disposed at the motor-side of the frame and an air gap between the end of the drum and the heat sink.

4. The drum mount of claim 1 wherein the transmission comprises a flange disposed at the distal end of the motor and the heat sink further comprises a plurality of tensioned fasteners extending along the motor and between the flange and the heat sink.

5. The drum mount of claim 1 wherein the connector element comprises an outer perimeter surface.

6. The drum mount of claim 5 wherein the drum comprises an inner surface and the outer perimeter surface of the connector element is in contact with the inner surface of the drum such that rotation of the connector element results in rotation of the drum when the connector element is fastened to the drum.

7. The drum mount of claim 1 wherein the motor-side of the frame further comprises a brake.

8. The drum mount of claim 1 wherein the motor-side of the frame comprises an aperture wherein a heat sink adapter mount is disposed within the frame and a heat sink portion extends through the motor-side of the frame and is attached to the proximal end of the motor.

9. The drum mount of claim 8 wherein the drum comprises an end disposed at the motor-side of the frame and an air gap exists between the proximal end of the drum and the heat sink portion that extends through the motor-side of the frame.

10. The drum mount of claim 8 wherein the transmission comprises a flange disposed at the distal end of the motor and the heat sink further comprises a plurality of tensioned fasteners extending along the motor and between the transmission flange and a heat sink mount flange.

11. The drum mount of claim 10 wherein the connector element comprises an outer perimeter surface.

12. The drum mount of claim 11 wherein the drum comprises an inner surface and the outer perimeter surface of the connector element is in contact with the inner surface of the drum such that rotation of the connector element results in rotation of the drum.

13. The drum mount of claim 1, together with the frame and drum, all comprising a drum mount assembly.

14. A drum mount for use with a roll-up door disposed within a doorway comprising:
a frame mounted about the doorway having a motor-side of the frame mounted to one side of the doorway;
a drum rotatable about an axis;
a motor for rotating the drum, the motor extending into the drum from the motor-side of the frame; and
a connector element;
wherein the motor and the connector element are mounted in a cantilevered fashion from the motor-side of the frame and within the drum;
wherein the motor as mounted as a stressed member for increased rigidity of the drum; and
wherein the connector element provides means for further increasing rigidity of the cantilever mounted drum.

15. The mount of claim 14 further comprising a heat sink disposed at the motor-side of the frame.

16. The drum mount of claim 14 further comprising a transmission.

17. The drum mount of claim 15 wherein the drum comprises an end disposed at the motor-side of the frame and an air gap between the end of the drum and the heat sink.

18. The drum mount of claim 14 wherein the connector element comprises an outer perimeter surface.

19. The drum mount of claim 18 wherein the drum comprises an inner surface and the outer perimeter surface of the connector element is in contact with the inner surface of the drum such that rotation of the connector element results in rotation of the drum when the connector element is fastened to the drum.

20. The drum mount of claim 14 wherein the motor-side of the frame further comprises a brake.
